(19) United States
(12) Patent Application Publication
(10) Pub. No.: US 2002/0107738 A1
(43) Pub. Date: Aug. 8, 2002

(54) Paperless coupon redemption method and apparatus

(76) Inventors: Kirk Beach, Issaquah, WA (US); Ian Melanson, Vancouver (CA)

Correspondence Address: PERKINS COIE LLP, PATENT-SEA, P.O. BOX 1247, SEATTLE, WA, 98111-1247, US

(21) Appl. No.: 10/020,587

(22) Filed: Oct. 30, 2001

Related U.S. Application Data
(60) Provisional application No. 60/244,447, filed on Oct. 30, 2000.
(60) Provisional application No. 60/154,006, filed on Sep. 15, 1999.
(60) Provisional application No. 60/154,123, filed on Sep. 15, 1999.

(51) Int. Cl. G06F 17/60

(52) U.S. Cl. 705/14; 705/16

(57) ABSTRACT

A system for reducing cost or burdens associated with conventional couponing is provided. In one aspect, a user registers, e.g., at a web site, the user's identification number or other number, and the user's bank account or other account. The user preferably identifies one or more coupons which are desired. After the user visits a retail location and makes purchases, a program in communication with the retail location point-of-sale computer verifies compliance with coupon criteria and authorizes or requests an appropriate monetary credit or deposit in the user's bank (or other) account.

### CROSS-REFERENCE TO RELATED APPLICATION(S)

This application claims the benefit of U.S. Provisional Application No. 60/244,447 filed Oct. 30, 2000, currently pending and incorporated herein by reference.

Cross reference is made to U.S. patent application Ser. Nos. 60/154,006 filed Sep. 15, 1999, and 60/154,123 filed Sep. 15,1999.

The present invention relates to a method and apparatus for redeeming coupons without the need for paper coupons and in particular to coupon redemption using a retail location purchase (point of sale) computer and/or database.

### BACKGROUND

Coupons are used in shopping by a large segment of the shopping population. Although many types of promotions can be used or have been proposed, as used herein, a coupon refers to a product or service promotion which provides a purchaser with a monetary value or incentive (including, e.g., a “cents-off” or percentage discount, rebate and the like) which can be redeemed only by purchasing certain items or services, classes of items or service or making certain other types of purchases. As an illustrative example, a coupon might provide a user with a one dollar discount only if the user purchases a one pound, two pound or three pound container of a specified brand of coffee.

Although coupons often have criteria (for redemption) of purchasing specific amounts, brands and the like, it is also possible to provide coupons which do not have brand name, amount, minimum purchase or similar restrictions. Although coupons are often provided by the manufacturer of goods (or provider of services) it is also possible for coupons to be provided by other entities such as organizations of multiple manufacturers, by retail establishments or chains, by groups or organizations of multiple retailers, by municipalities or other localities or government organizations, by charitable organizations, by schools, civic groups and the like. Although coupons are often issued with the intention of increasing sales or otherwise promoting commerce, coupons can be provided for other purposes such as governmental purposes, civic purposes, charitable purposes and the like.

Although coupons have proved popular with large segments of the shopping population and have been at least partially successful in achieving purposes such as promoting commerce, there are a number of problems associated with traditional couponing approaches. In a typical couponing approach, paper coupons, typically indicating the discount or other value and the purchase or other criteria needed for redemption, are distributed to all or portions of a potential shopping population. To redeem the coupons in traditional approaches, a consumer will visit a retail or service location, and purchase goods or services meeting the criteria for coupon redemption. The consumer will present the coupon at checkout (or upon payment), and will be credited with the redemption value of the coupon. The retail location will typically accumulate the coupons presented by various customers and, generally, must then sort the coupons according to the issuing entity, must convey the coupons to the issuing entity, sometimes with a proof or indication that the purchase criteria were met, and only then will receive a payment from the manufacturer, to compensate the retailer for the coupon redemption.

These and other traditional couponing procedures can create a costly burden on both the retailers, who must pay retail personnel for collecting, sorting, verifying, redeeming coupons and receiving remuneration from the manufacturer or other coupon-issuer, as well as the manufacturer or coupon issuer who must verify the legitimacy of the coupons and the associated purchases and must provide payment to numerous different redeeming retailers. Accordingly, it would be useful to provide a couponing system method and apparatus which can reduce or eliminate certain costs associated with traditional (typically paper) couponing.

Traditional couponing also places certain burdens on the consumer. In traditional couponing, the consumer must accumulate the various coupons for desired items, often from numerous different sources (such as newspapers or other publications, mailings, and the like) and must remember to bring these (typically paper) coupons to the retail location, must go to retail locations which sell the particular brands or other items or services, which the coupons are for (sometimes requiring consumers to go to considerable trouble in order to locate a retailer selling the particular item) and must remember to present the coupons to the retailer at checkout. Accordingly, it would be useful to provide a couponing system method and apparatus which can reduce or eliminate certain of the tasks or problems borne by consumers in traditional couponing.

It has been found that traditional couponing is sometimes accompanied by an amount of error, or even fraud, such as when a consumer, with or without collusion of a retail location personnel, obtains a coupon redemption without meeting the coupon criteria (e.g., without buying the required product or service). There is also a risk that print coupons can be altered or forged, so that retailers pay a redemption amount but do not receive compensation from a manufacturer (because they present a coupon which the manufacturer, recognizing as altered or forged, will not honor). Other potentials for retailer or manufacturer loss arising from error or fraud will be understood by those of skill in the art. Accordingly, it would be useful to provide a couponing system method and apparatus which can reduce or eliminate instances of at least certain types of losses arising from error or fraud in connection with couponing.

In general, traditional couponing systems include retailer involvement both in setting up the couponing system (e.g., making arrangements with manufacturers to compensate retailers for redeeming the manufacturer's coupons, and the like) and in the actual redemption process (receiving, verifying, sorting, redeeming and requesting compensation for coupons). Because of the burden that such previous or traditional couponing systems has placed on retailers, it is believed that retailers are (understandably) reluctant to undertake new couponing systems which appear to involve substantial retailer effort. Accordingly, it would be useful to provide a couponing system, method and apparatus which can be implemented or set up without requiring undue involvement or effort on the part of retailers (e.g., without requiring substantial reprogramming or modification of retailer's point-of-sale or other computers) and which can reduce or substantially eliminate the involvement of retailers in the couponing system (e.g., so that retailers are relieved from some or all of the tasks of receiving, verifying, redeeming, sorting and/or requesting compensation, for couponing).

### SUMMARY

The present invention includes a recognition of the existence, nature and/or source of problems in previous approaches, including as described herein. In one aspect, coupon redemption and verification is performed electronically, e.g., by a computer-implemented procedure for comparing a consumer's purchases, typically stored on or using a retailer's point-of-sale (POS) computer system, with electronic information indicating the purchase requirements or criteria for various coupons. In one embodiment, the coupons for which a particular consumer is eligible consists of or include coupons which the consumer previously registered for (e.g., at a Internet web site or otherwise electronically). Information about which coupons a consumer is eligible for, and/or information about the purchases of the consumer, can be transmitted electronically between, e.g., the web site and the retail location (or other location where the coupon redemption occurs). Thus, in at least some embodiments, there is no need for consumers to present physical paper coupons to the retailer.

Preferably, when coupons have been electronically verified, the payment of the coupon amount, to the consumer, also occurs electronically, such as by transferring funds to a consumer's account. Accordingly, in at least some embodiments, the retailer is relieved from receiving, verifying, or redeeming the coupons, yet the consumer can obtain, use and receive monetary benefits from coupons.

In one aspect, a system for reducing cost or burdens associated with conventional couponing is provided. In one aspect, a user registers, e.g., at a web site, the user's identification number or other number, and the user's bank account or other account. The user preferably identifies one or more coupons which are desired. After the user visits a retail location and makes purchases, a program in communication with the retail location point-of-sale computer verifies compliance with coupon criteria and authorizes or requests an appropriate monetary credit or deposit in the user's bank (or other) account.

### BRIEF DESCRIPTION OF THE DRAWINGS

FIG. 1 is a block diagram depicting components of a system and apparatus for couponing, according to embodiments of the present invention;

FIG. 2 is a flow chart depicting steps in a couponing procedure according to an embodiment of the present invention; and

FIG. 3 is a flow chart depicting steps in a coupon redemption procedure according to an embodiment of the present invention.

### DETAILED DESCRIPTION

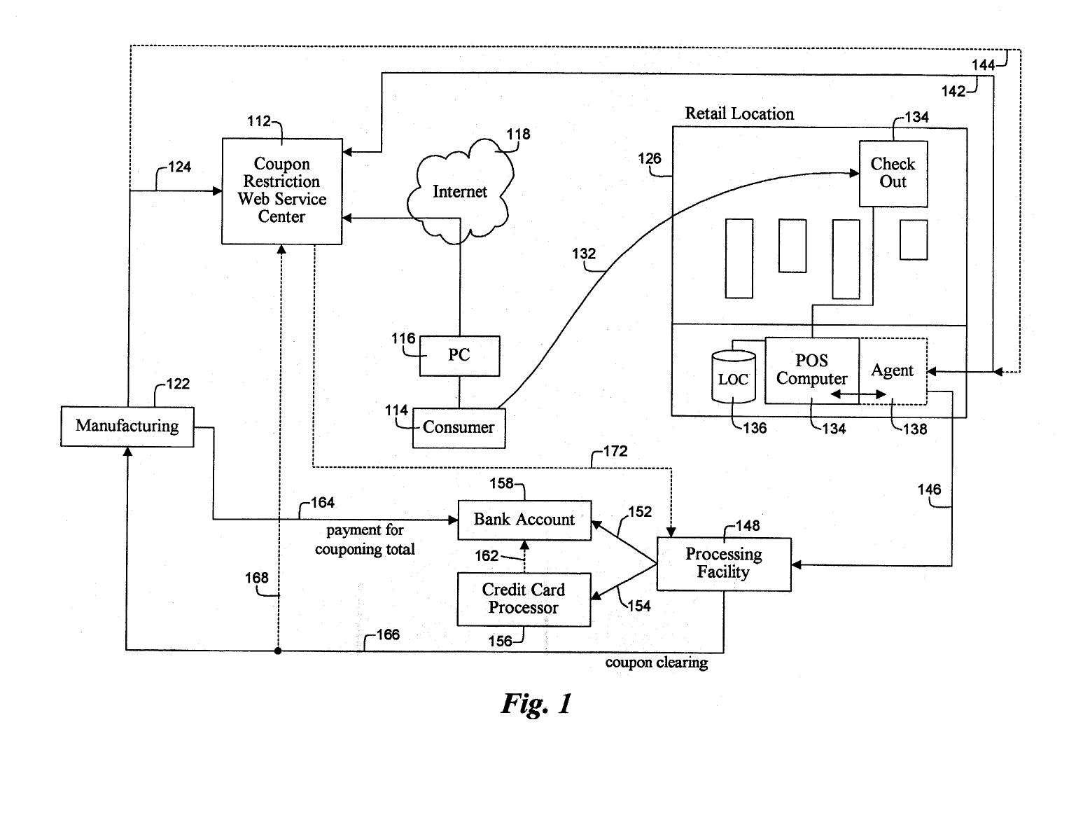

As depicted in FIG. 1, according to one embodiment, a coupon registration service center 112 is available for communication with a consumer 114. Preferably, the service center 112 is available for electronic communication, such as communication using a consumer's personal computer 116 for communicating over the Internet 118. Preferably, the operations and steps performed by the service center 112 can be performed in a computer-implemented fashion, preferably substantially automatically (i.e., partially or entirely by computer, without the need for human performance of such operations or steps, although human performance can be used for some operations or steps, if desired, without departing from the spirit or scope of the present invention).

One function of the service center 112 is the storage of information, (in a fashion so that it will be accessible for purposes as described below) which can associate an identification of the consumer (such as a consumer identifier number including, e.g., “frequent shopper” numbers, credit card numbers, bank account numbers, social security number, telephone number, or other identifier numbers) or consumer name, address and similar identifying information, with one or more accounts where monetary deposits can be made, such as bank accounts, credit card or debit card accounts, trust accounts, investment accounts, store or other retail or service location, customer accounts and the like. A primary purpose of obtaining and storing such information is so that, when the consumer has fulfilled a criteria or requirement for a coupon (such as by purchasing a product or service), the coupon value can be deposited in the correct consumer's account. It is, however, possible to provide embodiments of the invention in which the amount is not transferred to a bank or credit card account (such as when the value of the coupon is credited to the consumer's store account) and thus there are embodiments in which the service center 112 does not need to obtain or store such account information.

Another function of the service center 112, in at least some embodiments, is to allow a consumer to register for, or electronically obtain, desired coupons. In these embodiments, in place of the previous systems which involves consumers gathering desired coupons, e.g., from publications and the like, the consumer would indicate a desire for particular coupons described or displayed on a web site (or otherwise electronically described or displayed). Information indicating which coupons have been selected by a particular consumer would be stored on or by the service center computer 112 (for use as described below).

It is also possible to provide embodiments in which some or all coupons can be redeemed by a consumer without having first registered or stored an indication of a desire for a coupon. Such a system would be somewhat analogous (although not identical) to current so-called instant coupons in which coupons are provided with (sometimes attached to) products in the store (so that the user does not need to accumulate the coupons, prior to visiting the store). In these embodiments, the need for using the service center 112 for the purpose of a consumer choosing particular coupons may be reduced or eliminated.

In those embodiments in which the consumer selects coupons, e.g., at a web site or other service center 112, the service center 112 must first have information about the various coupons which have been authorized for offering to the public. In the embodiment depicted in FIG. 1, information about coupons is provided to the service center 112 by various manufacturers 122. However, as will be understood by those of skill in the art, numerous different entities can issue coupons and, in various embodiments, a service center 112 may receive coupon authorization or information, in addition to or in place of one or more manufacturers 122, from service providers, retail stores or chains, organizations of manufacturers, organizations of retailers, municipalities, chambers of commerce, government organizations, tourism bureaus, charitable organizations, civic organizations and the like.

It is possible to provide systems in which numerous different web sites 112 act as service centers and it is possible to provide embodiments in which any or all of various web sites which act as service centers, can provide coupons from many different coupon issuers (including those that may be competitive with one another) or which may be restricted (e.g., including those which may be operated by a particular manufacturer and thus may exclude coupons of competitive manufacturers and the like).

Information from a manufacturer 122 (or other entity) can be provided to the service center 112 using a number of information transfer links 124 including transferring (preferably encrypted) information over an Internet link (or other communication link).

In the embodiment depicted in FIG. 1, a coupon is redeemed when a user makes a qualifying or required purchase at any of a plurality of retail locations 126. As used herein a qualifying purchase is a purchase which complies with criteria associated with at least one coupon entitling the purchaser to monetary or other benefits of the coupon. To assist a user in selecting a retail location 126 where qualifying purchases may be made, in one embodiment, the service center 112 can be configured to display, to a consumer 114, the locations, names, addresses and the like of retail locations 126 where qualifying purchases for various coupons can be made.

When a visitor or consumer 114 visits 132 a retail location 126 and purchases items, as the items are entered at a check-out or sales location 134 (such as by scanning product codes or the like), information regarding the consumer's purchases is provided to a backroom or point-of-sale (POS) computer 134. Although a point-of-sale computer 134 is typically located in the retail location 126, embodiments of the present invention can also be implemented when information from check-out stations 134 is provided to remotely-located computers. Typically, a POS computer 134 will maintain a log of consumer's purchases, e.g., on a disk drive or other storage device 136. The POS computer 134 is preferably provided with information regarding the identity (or an identifier number) of the consumer 114 such as when the consumer uses a frequent shopper card, a credit card or other identifying card or token, or otherwise provides identifying information during the retail checkout procedure. Preferably, the information identifying the computer 114 and provided to the POS computer 134 either is the same information which the consumer 114 used as an identification when communicating with the service center 112, or is information which can be used to access or retrieve the identifying information which the consumer used in communicating with the service center 112. For example, it is possible for a consumer to provide a credit card number as an identifier when communicating with the service center 112, but to use a frequent shopper card or number during the checkout procedure at the retail location 134. However, if the retail location has (or can access) a database which correlates the consumer's frequent shopper number with the consumer's credit card number, the POS computer still has sufficient information to correlate the consumer 114 who purchases item at the checkout 134 with an identification of a consumer who has communicated with the service center 112.

Although it is possible to implement embodiments of the invention by modifying or reprogramming the POS computer 134, in the embodiment depicted in FIG. 1, a separate agent 138 (i.e., a program for implementing at least some of the procedures of embodiments of the present invention, as described below) is provided which can work in conjunction with the POS computer 134 and/or stored data 136, preferably while requiring little or substantially no reprogramming or modification of the POS computer software 134. By providing a separate agent program or module, it is possible to implement embodiments of the present invention while substantially minimizing any inconvenience to the retailer. Furthermore, it is possible to provide agents which can be configured to work with a plurality of different POS computers or programs 134 (possibly with some amount of configuration or modification), so that embodiments of the present invention can be implemented across a wide variety of retailers.

In one embodiment, one function of the agent 138 is to verify or identify purchases which qualify or fulfill requirements connected with coupons. Accordingly, the agent 138 communicates 142 with the service center 112 (or, in some cases, directly with a manufacturer 144) in order to effect the verification or identification of qualifying purchases, e.g., as described more thoroughly below.

According to one embodiment of the invention, the identification or verification of qualifying purchases does not need to occur simultaneously with the purchases made by the consumer 114. For example, the system can be configured such that the agent 138 will remain substantially idle until such time as the level of activity at the point-of-sale computer 134 drops to a relatively low level. For example, the system can be configured to perform the verification or identification in a substantially batch fashion, during low activity time periods (e.g., at night or when the retail location is closed). In one embodiment, successful or completed redemptions are reported or stored by the service center 112 so that, if desired a user can verify that redemption was completed (e.g., by visiting the web site, the next day).

It is also possible to provide embodiments of the invention in which some or all of the identification or verification of qualifying purchases is performed substantially simultaneously with the purchaser's or consumer's visit to the retail location. In these embodiments, if desired, a consumer can be provided with a verification (e.g., on a printed register tape or otherwise) that redemption has been authorized.

In the embodiment depicted in FIG. 1, when a agent 138 has determined that a customer's purchases have entitled the customer to a monetary amount, as a result of coupon redemption, the agent 138 preferably will take actions to ensure that the monetary amount is credited to an account of the consumer 114 (such as the account which the consumer 114 previously identified, during his or her communications with the service center 112). In the embodiment of FIG. 1, the agent provides the redemption totals for the consumer 114 over a communication link 146 to a processing facility 148. Although FIG. 1 depicts the processing facility 148 as a separate facility, it is possible to provide embodiments in which some or all of the processing is performed by the agent 138, by the POS computer 134 and/or by the service center 112.

In the embodiment of FIG. 1, the processing center will send information indicating the identity of an account and the amount to be credited, to the account entity (such as to a bank) for crediting to a bank account 152, or to a credit card (or debit card) processor entity (for crediting to a credit card account 154) and the like. In some cases, where a credit card entity 156 is associated with a bank 158, credits to the credit card processor 156 may be automatically deposited 162 in a corresponding bank account 158.

In order for, for example, a bank 158 to increment the consumer's account by a certain amount, the bank will receive a corresponding payment 164 (or payment authorization) from the manufacturer 122 or other entity which issued the coupon. The manufacturer 122 thus will receive information 166 from the processing facility 148, informing the manufacturer that a certain amount of couponing funds have been credited to certain banks so that the manufacturer 122 will know that it should transfer the funds 164.

Although there may be situations in which coupons have an unlimited quantity (so that, for example, if a coupon authorizes one dollar off a purchase of coffee, the consumer can, if desired, purchase 12 cans of coffee and receive $12.00), other coupons are limited (such that if the consumer wishes to obtain discounts when purchasing two cans of coffee, the user must obtain two coupons). At least in the case of quantity-limited coupons, when a coupon has been redeemed, this information is provided to the service center 112 (either directly by the agent 144 or by communication 168 from the processing facility 148). In this way, after a coupon has been redeemed, if the consumer 114 then visits another store and makes another qualifying purchase, the communication 142 between the agent 138 and service center 112 will reveal that the consumer is not entitled to another coupon redemption since the coupon has already been redeemed.

Those of ordinary skill in the relevant art will appreciate that the present invention may be practiced in a number of different embodiments in accordance with the present disclosure. In one such embodiment, a single consumer identifier (or identifying number) can be used across multiple retailers. Each time the consumer identifying number is used at one of the retailers, the retailer's POS will transmit relevant transaction information to the central database. This embodiment allows “group promotions,” wherein a user is offered a credit or similar benefit at one retailer by making prescribed transactions at one or more other retailers. For example, in one such group promotion, the user may be offered a free admission to a movie if the user purchases a dinner from a particular restaurant chain and a tank of gas from a particular gas station chain.

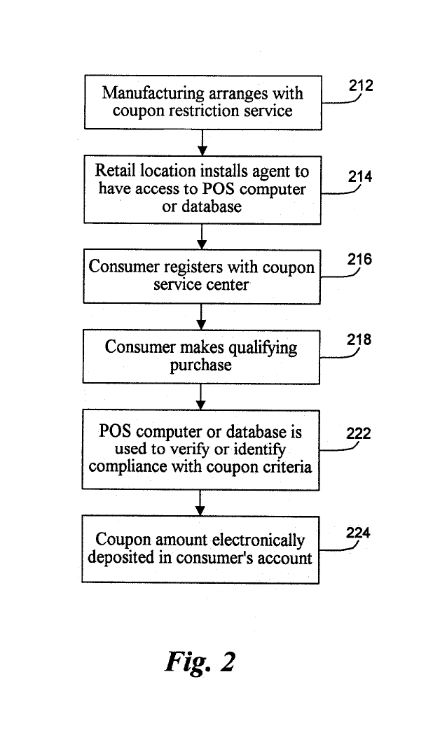

In practice, as depicted in FIG. 2, a manufacturer (or other entity) will arrange with a coupon registration service center 212 for the issuance of coupons. The service center 112 will store the appropriate information defining the coupons (such as value of the coupon, time limits or quantity limits on validity, types of purchases required to redeem and the like), e.g., on a disk drive or similar storage device. Various retail locations 126 will have agents 138 installed 214 having access to the store's POS computer 134 and/or database 136. The consumer 114 communicates or registers 216, e.g., using an Internet connection 118 or other communication means, with the service center 112. Although a number of embodiments are possible, in at least one embodiment, the user will, e.g., on a first visit to the web site, provide an identifying number (such as a frequent shopper number, name and address, credit card number and the like) and will identify a bank account, credit card account or other account to which coupon credits will be deposited. In some embodiments, this information may be provided to, or obtained by, the service center 112 in a substantially automatically or transparent fashion (such as by storing or retrieving Internet “cookies”). In at least some embodiments, the user can select among various coupons which the user would like to take advantage of. Preferably the service center 112 provides a user interface and/or software to assist the consumer in selecting desired coupons and/or to promote coupons or products of various manufacturers, retailers and the like. For example, in some embodiments the user may enter or download some or all items from a shopping list (including an electronic shopping list) and the service center 112 will search a database to locate coupons which exactly or roughly correspond to items which the consumer intends to purchase. In some embodiments, the service center may suggest items or coupons to the user, e.g., for based on information stored or accessible to the service center 112 regarding the consumer or the consumer's family or other group. Systems for suggesting shopping items and/or coupons can be used similar to those described in U.S. patent application Ser. No. 60,153,965 (Attorney File 3730-918), incorporated herein by reference. Preferably, the service center 112 can be configured to provide the consumer 114 with a (preferably printable) display showing the items (or classes of items) which the consumer must purchase in order to qualify for the coupons and/or showing the name, address or other location of one or more retail locations where such items can be purchased (and which are configured with an agent 138 for automatic fulfillment or redemption, as described herein). If desired, the service center 112 can be configured to communicate the list of coupon items, preferably associated with the consumer's frequent shopper number or other identifier, to a facility at one or more retail locations 126 so that a consumer can retrieve the list of items to purchase (for coupon redemption) at the retail location, e.g., as generally described in U.S. patent application Ser. No. 60,154,006, supra. The consumer visits the retail location 126 and makes one or more qualifying purchases 218. At the time of checkout 134, or at a later time, the agent 138 uses information in the POS computer 134 or database 136 to verify or identify compliance with coupon criteria 222, i.e., to verify or identify purchases which fulfill requirements for redemption of one or more coupons (e.g., as described more thoroughly below.) Thereafter, the coupon amount for such redeemed coupons are electronically deposited 224 in a consumer's account, such as a bank account 158 or the like.

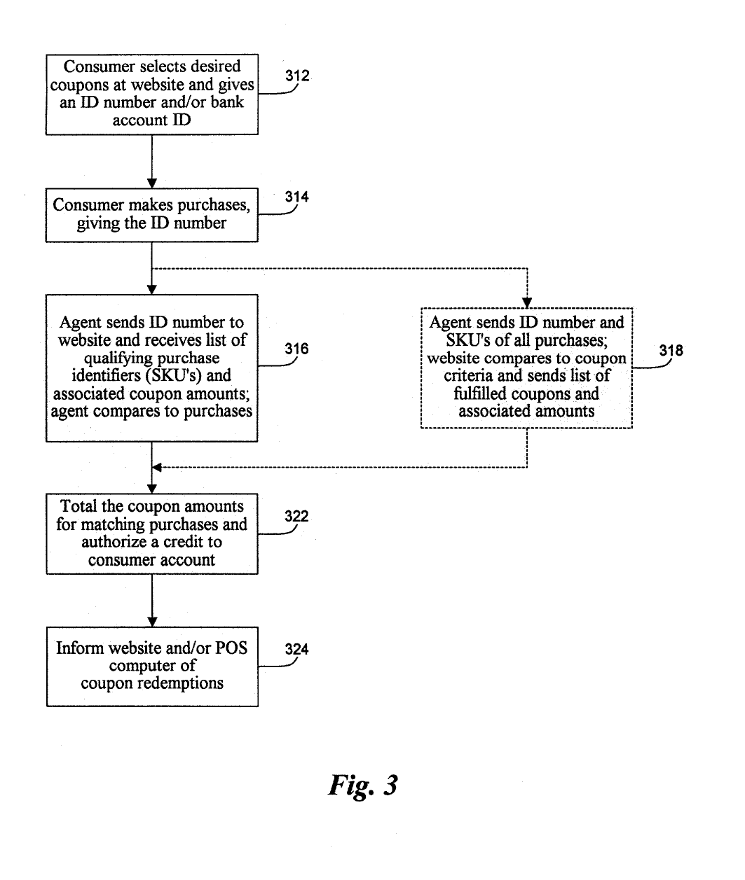

In the embodiment depicted in FIG. 3, after a consumer selects one or more desired coupons, e.g., at the web site 112 and has provided an identification number and/or a bank account or other account identifier 312, the consumer makes purchases 314 in a manner which gives the POS computer 134 an identification number for the consumer, such as a frequent shopper number, credit card number or the like. In one embodiment, in order for the agent 138 to determine whether any of the consumer's purchases qualify the consumer for a coupon redemption, the agent will send the consumer's identification number 316 to the service center 112. In response, the service center 112 will locate information corresponding to that consumer identification number and will return to the agent a list of coupons (or similar information) which the consumer may qualify for, including coupons that the consumer 114 has requested or identified as being of interest, during a prior communication. In one embodiment, the service center 112 returns at least a list of identification numbers (e.g., UPC or SKU numbers) for items which qualify the consumer for one or more coupon redemptions, along with the amount of such redemptions. The agent 138 then compares the items which qualify the consumer for a coupon redemption to the items which the consumer actually purchased, to determine whether any redemptions should be awarded.

In at least one embodiment, a match between a consumer's purchases and the coupon-qualifying products is detected if a UPC or SKU of at least one item purchased by the consumer is identical to an SKU or UPC code for a qualifying product associated with a coupon. In other cases, there may be additional coupon requirements such as time limits, quantity limits, location limits and the like and, in these embodiments, a match may be determined only if such additional limitations are complied with, in addition to a match of SKUs or UPCs.

In another embodiment, the agent sends to the service center 112 not only the consumer's identification number but also the codes (SKUs) for all the purchases made by the consumer 318. In this embodiment, the comparison (between the requirements for various coupons and the actual purchases) is performed by the service center 112, rather than by the agent 138. If the service center 112 finds any qualifying purchases, entitling the consumer to some coupon redemptions, the service center 112 will send a list of all fulfilled or redeemed coupons, and/or the associated amounts of such coupons, to the agent 138. The total for all the various coupons which are redeemed, in response to the purchases made by the consumer, is then used to authorize a credit to an account of the consumer 322.

Although in the embodiment of FIG. 1, it is the agent 138 which provides communication 146 resulting in a credit to the consumer's account, it is also possible to provide embodiments in which the service center 112 provides a communication 172 to authorize such deposit to an account. In any event, preferably either the agent 138 or the processing facility 148 provides a communication 144, 168 to the web site 112 and/or to the POS computer 134, of the existence of, or granting of, the coupon redemptions 324. For example, it can be useful to store coupon redemption information in the POS computer 134 so that if a customer returns merchandise to the retail location 126 for a refund, the refund amount can be calculated taking into account any coupon redemptions that have been granted.

In light of the above description, a number of advantages of the present invention can be seen. The present invention can provide consumers with desirable advantages and benefits associated with couponing while reducing or eliminating many of the costs and processing burdens associated with previous couponing systems. For example, the present system can be used to relieve retailers from the burden of receiving, verifying, redeeming, sorting and requesting compensation for coupons. The present invention can reduce or eliminate the need for consumers to accumulate, bring or present paper coupons at, or to, a retail location. The present invention can assist in avoiding modification or counterfeiting that is associated with paper coupons. The present invention can assist in reducing or eliminating fraud, e.g., of a type involving obtaining a redemption without making the qualifying purchase (at least because qualifying purchases are verified by an electronic and/or computer-implemented system, without the need for human intervention and/or the potential for human errors or fraud). The present invention can contribute to enhanced flexibility and creativity in couponing systems since manufacturers can readily change a couponing strategy by merely sending electronic information to various service centers, without the cost and delay associated with printing and distributing paper coupons.

A number of variations and modifications of the invention can be used. It is possible to use some features of the invention without using others. For example, it is possible to use a system which provides for electronic verification of or identification of qualifying purchases without using electronic funds transfer for providing remuneration to consumers, and by vice versa. Although embodiments of the present invention have been described as being implemented using one or more Internet links or connections for transferring information, it is possible to use other types of communication links for some or all of these purposes, including local area networks (LANs) telephone communication links, including cellular or other fully or partially wireless links, infrared or microwave communication links, satellite communication links, optical fiber or other optical communication links and the like.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and/or reducing cost of implementation. The present invention includes items which are novel, and terminology adapted from previous and/or analogous technologies, for convenience in describing novel items or processes, do not necessarily retain all aspects of conventional usage of such terminology.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. Apparatus useable by at least a first plurality of consumers in connection with coupon redemption comprising:
at least a first service center computer configured, for each said consumer, to
store first consumer identification information for said consumer and
store an account identification for at least a first account of said consumer;
an electronic storage device controlled to store at least first coupon information for each of a plurality of coupons, said first coupon information including a redemption value and a qualifying purchase identification, said first coupon information being accessible by at least one of said first service center computer and a point-of-sale computer system;
said point-of-sale computer system configured for storing second identification information for a second plurality of consumers, at least some of said second plurality of consumers being members of said first plurality of consumers, said point-of-sale computer system storing, for each said second consumer identification, a list of purchases made by each consumer; and
a facilitating computer, configured to execute at least an agent program which can communicate with said point-of-sale computer and said service center computer, said agent program being configured to compare purchases in said list of purchases with said qualifying purchase identification of said first coupon information and,
when a match is identified, defining a matched coupon and a matched consumer, to deposit an amount, based on a redemption value of at least said matched coupon in an account of said matched consumer.

2. Apparatus as claimed in claim 1 wherein said facilitating computer is said point of sale computer.

3. Apparatus as claimed in claim 1 wherein said facilitating computer is said service center computer.

4. Apparatus as claimed in claim 1 wherein said consumer identification information includes information selected from the group consisting of:
a frequent shopper number;
a credit card account number;
a debit card account number;
a name;
an address;
a telephone number;
a social security number;
an email address; and
a password.

5. Apparatus as claimed in claim 1 wherein said list of purchases is obtained in response to a retail location check-out procedure.

6. Apparatus as claimed in claim 1 wherein said electronic storage device is directly coupled to said service center computer.

7. Apparatus as claimed in claim 1 wherein said service center computer is programmed to store identification of at least a first coupon selected by a consumer, associated with identification information of said consumer.

8. Apparatus as claimed in claim 1 wherein said first coupon is selected using an Internet communications link.

9. A method useable by at least a first plurality of consumers in connection with coupon redemption comprising:
storing, in at least a first service center, for each said consumer, first consumer identification information for said consumer and an account identification for at least a first account of said consumer;
storing, in an electronic storage device at least first coupon information for each of a plurality of coupons, said first coupon information including a redemption value and a qualifying purchase identification, said first coupon information being accessible by at least one of said first service center computer and a point-of-sale computer system;
storing, in said point-of-sale computer system, a list of purchases made by each of a second plurality of consumers, and second identification information for each of said second plurality of consumers, at least some of said second plurality of consumers being members of said first plurality of consumers;
comparing purchases in said list of purchases with said qualifying purchase identifications of said first coupon information;
when a match is identified, defining a matched coupon and a matched consumer; and
depositing an amount, based on a redemption value of at least said matched coupon, in an account of said matched consumer.

10. A method as claimed in claim 9 wherein said step of comparing is performed by said point-of-sale computer.

11. A method as claimed in claim 9 wherein said step of comparing is performed by said service center computer.

12. A method as claimed in claim 9 wherein said consumer identification information includes information selected from the group consisting of:
a frequent shopper number;
a credit card account number;,
a debit card account number;,
a name;
an address;
a telephone number;
a social security number;
an email address; and
a password.

13. A method as claimed in claim 9 wherein said list of purchases is obtained in response to a retail location check-out procedure.

14. A method as claimed in claim 9 wherein said electronic storage device is directly coupled to said service center computer.

15. A method as claimed in claim 9 further comprising storing, in said service center computer, identification of at least a first coupon selected by a consumer, associated with identification information of said consumer.

16. A method as claimed in claim 15 wherein said first coupon is selected using an Internet communications link.

17. Apparatus useable by at least a first plurality of consumers in connection with coupon redemption comprising:
first means for storing, for each said consumer, first consumer identification information for said consumer and an account identification for at least a first account of said consumer;
second means for storing at least first coupon information for each of a plurality of coupons, said first coupon information including a redemption value and a qualifying purchase identification, said first coupon information being accessible by at least one of said first means for storing and a third means for storing;
storing, in said third means for storing, a list of purchases made by each of a second plurality of consumers, and second identification information for each of said second plurality of consumers, at least some of said second plurality of consumers being members of said first plurality of consumers;
means for comparing purchases in said list of purchases with said qualifying purchase identifications of said first coupon information and for defining, when a match is identified, a matched coupon and a matched consumer; and
means for depositing an amount, based on a redemption value of at least said matched coupon, in an account of said matched consumer.

18. Apparatus, as claimed in claim 17 wherein said first means for storing comprises a service center computer, accessible to consumers over an Internet link and wherein said second means for storing comprises a point-of-sale computer coupled to a retail location.

19. Apparatus as claimed in claim 18 wherein said means for comparing is said point-of-sale computer.

20. Apparatus as claimed in claim 18 wherein said means for comparing is said a service center computer coupled to said first means for storing.

21. Apparatus as claimed in claim 17 wherein said consumer identification information includes information selected from the group consisting of:
a frequent shopper number;
a credit card account number;
a debit card account number;
a name;
an address;
a telephone number;
a social security number; and
a password.

22. Apparatus as claimed in claim 18 wherein said list of purchases is obtained in response to a check-out procedure at said retail location.

23. Apparatus as claimed in claim 18 wherein said second means for storing is directly coupled to said service center computer.

24. Apparatus as claimed in claim 18 further comprising means for storing, in said service center computer, identification of at least a first coupon selected by a consumer, associated with identification information of said consumer.

25. Apparatus as claimed in claim 24 wherein said first coupon is selected using an Internet communications link.

26. A computer implemented-method for coupon fulfillment comprising:
purchasing, by a consumer, at least a first product;
electronically storing indications of products purchased by said consumer, including said at least first product, to provide a first list;
comparing, in at least a first computer, a second list, of products associated with a plurality of coupons, to said first list;
electronically depositing an amount associated with at least one of said plurality of coupons, in an account associated with said consumer, if a match is detected between items on said first list and said second list.
